(19) United States
(12) Patent Application Publication
(10) Pub. No.: US 2005/0096412 A1
(43) Pub. Date: May 5, 2005

(54) Rubberized concrete composition and method of making the same

(76) Inventors: Vilem Petr, Golden, CO (US); Tibor G. Rozgonyi, Golden, CO (US)

Correspondence Address: SHERIDAN ROSS PC, 1560 BROADWAY, SUITE 1200, DENVER, CO, 80202, US

(21) Appl. No.: 10/777,623

(22) Filed: Feb. 11, 2004

Related U.S. Application Data
(60) Provisional application No. 60/517,803, filed on Nov. 5, 2003.

(51) Int. Cl. C08L 1/00

(52) U.S. Cl. 524/3; 106/697; 106/802

(57) ABSTRACT

The present invention provides a concrete composition that utilizes rubber aggregate with a distinct geometric shape. Preferably, the source of the rubber constituting the aggregate is used rubber tires cut by special saws or high pressure water jets to provide a smooth finished edge. Moreover, additional materials such as superplasticizers, fly ash, carbon fiber, fiberglass, and steel may also be mixed with the concrete compositions to vary the finish product's material properties.

This application claims the benefit of U.S. Provisional Patent Application Ser. No. 60/517,803, filed Nov. 5, 2003, which is incorporated by reference herein in its entirety.

### FIELD OF THE INVENTION

The present invention relates to concrete compositions containing particulate rubber aggregates preferably obtained from recycled material, such as used automobile tires.

### BACKGROUND OF THE INVENTION

Concrete has been employed in many road and building applications for centuries. One modern day use relates to impact barriers frequently employed on interstate highways, and which reduce the likelihood of head on collisions when automobiles inadvertently cross a median, for example. Impact barriers are designed to facilitate deformation of a moving body by redirection of momentum energy back into the impacting object, thereby dissipating the energy. However, in any impact, energy is ultimately absorbed. In some materials, this energy absorption is translated into elastic deflection, wherein the material subsequently returns to its original shape, thus releasing deformation energy and heat. However, most materials, even those that behave with elastic Hookean behavior, have limits wherein the material will deform permanently or fracture when exposed to a significant load. Concrete and other common building materials belong to this category. These materials are generally brittle, relatively weak in tension, strong in compression, and are prone to chipping or fracturing when impinged upon.

Tires are made predominately from rubber, which is either made from the milky sap of various tropical plants, or synthesized from oil or other organic chemicals. Rubber is generally very elastic, tough, durable, and may be made extremely strong depending on forming techniques, such as heat treatments that are well known in the art. Unfortunately, rubber is often detrimental to the environment. The harvesting of natural rubber threatens rainforests and other ecosystems. In addition, the disposal of rubber has become a world wide problem. Mountains of used tires, which litter portions of the United States, are prone to combustion, and may remain in landfills for decades. Furthermore, the burning of used tires causes noxious plumes of thick smoke.

Thus, there is a long felt need in the field of construction to provide a composite concrete material that includes an additive that enhances fracture toughness. In addition, there is a long felt need to provide a more efficient way to dispose of rubber products in an environmentally friendly manner. The foregoing description of the invention describes a concrete-based material with an enhanced tolerance to impact and which employs rubber aggregate of a predetermined size and shape.

### SUMMARY OF THE INVENTION

It is thus one aspect of the invention to provide a strong, impact resistant concrete material which is tough and utilizes an inexpensive source of rubber aggregate. Preferably, one embodiment of the present invention utilizes rubber particles in amounts between about 0.01 and 35 percent by weight of the concrete composition. The composition of the present invention is termed a “composite concrete” in that it generally contains a mixture of cement, water, fine and coarse aggregate, and the rubber tire aggregate components. In addition, plasticizers, superplasticizers, fly ash, or other additives may be employed to increase the adhesion of particles and to create a stronger finished product. Further, metallic materials such as steel may be used, as well as fiberglass, carbon fiber, and other materials capable of providing additional strength to the composition.

Generally the first step in creating a composition of the present invention begins by selecting predetermined sizes and shapes of aggregate. Generally, a sieve is used to sort aggregates by size, wherein apertures in the sieve allow smaller sized particles to pass through while capturing larger particles. A preferred particle size distribution for the rubber aggregate in one embodiment is such that from about 50-95 weight percent of the rubber aggregate particles are adapted to pass through a 1 inch sieve, about 20-75 weight percent of the rubber aggregate particles are adapted to pass through 0.95 inch sieve, and from about 0-30 weight percent of the aggregate particles are adapted to pass through 0.85 inch sieve. Generally, less than about 10 weight percent of the rubber aggregates are retained on 0.75-inch sieve.

It is another aspect of the present invention to provide a concrete composition that is adapted to be easily formed by casting. Concrete has many uses besides building and highway construction. More specifically, concrete is used in outdoor furniture, impact barriers, sculptures, bridge structures, etc. The present invention is adapted to be formed, poured, and laid to suit any of the various uses of concrete generally known.

It is a further aspect of the present invention to provide a blast or impact resistant building material that is resistant to deformation or collapse resulting from an extreme impact or blow from an explosive device or speeding automobile or truck. Further, it is another aspect of the present invention that the present invention is well suited as an earthquake resistant material, since it facilitates additional flexure and is less brittle than traditional concrete compositions.

It is still yet another aspect of the present invention to enhance the strength and performance characteristics of a concrete/rubber composite material by utilizing rubber with unique geometric shapes. More specifically, in one embodiment of the present invention, offset rectangular shaped aggregates are employed that enhance the torsional load capability of the material. The aggregate shape of this embodiment of the invention may be easily cut or punched in great numbers from a single tire, thus reducing the cost of the finished product.

The Summary of the Invention is neither intended nor should it be construed as being representative of the full extent and scope of the present invention. The present invention is set forth in various levels of detail in the Summary of the Invention as well as in the attached Figures and the Detailed Description of the Invention and no limitation as to the scope of the present invention is intended by either the inclusion or non-inclusion inclusion of elements, components, etc. in this Summary of the Invention.

### BRIEF DESCRIPTION OF THE DRAWINGS

FIG. 1 are front perspective views of various shapes of rubber aggregate particles of one embodiment of the present invention;

FIG. 2 are front section views of various combinations of rubberized and standard concrete;

FIG. 3 is a graph that depicts the rubberized aggregate particle size distribution used in making a concrete composition of one embodiment of the present invention;

FIG. 4 are front elevation views of alternative embodiments of the present invention; and

FIG. 5 is a front elevation view of a cutting pattern employed to produce one embodiment of the present invention.

### DETAILED DESCRIPTION

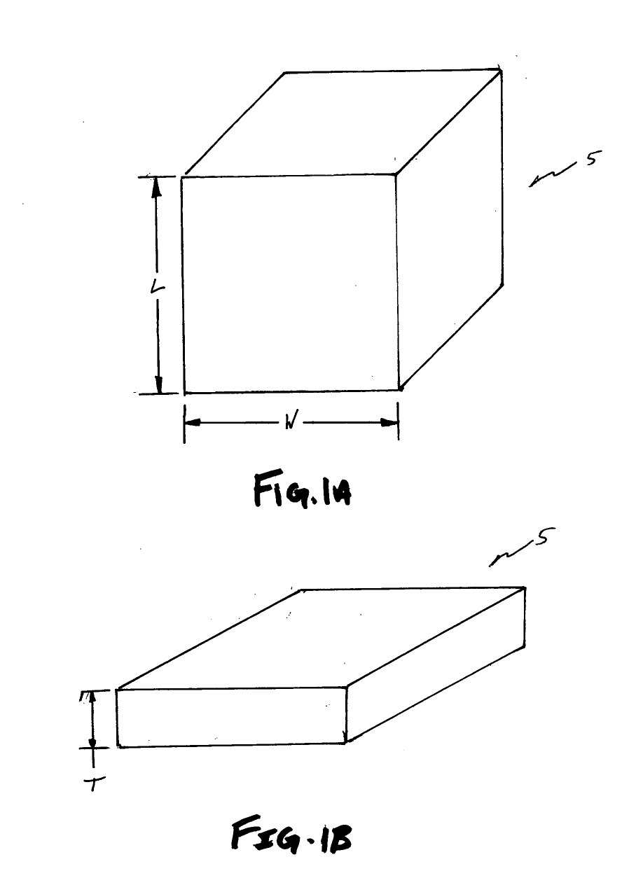

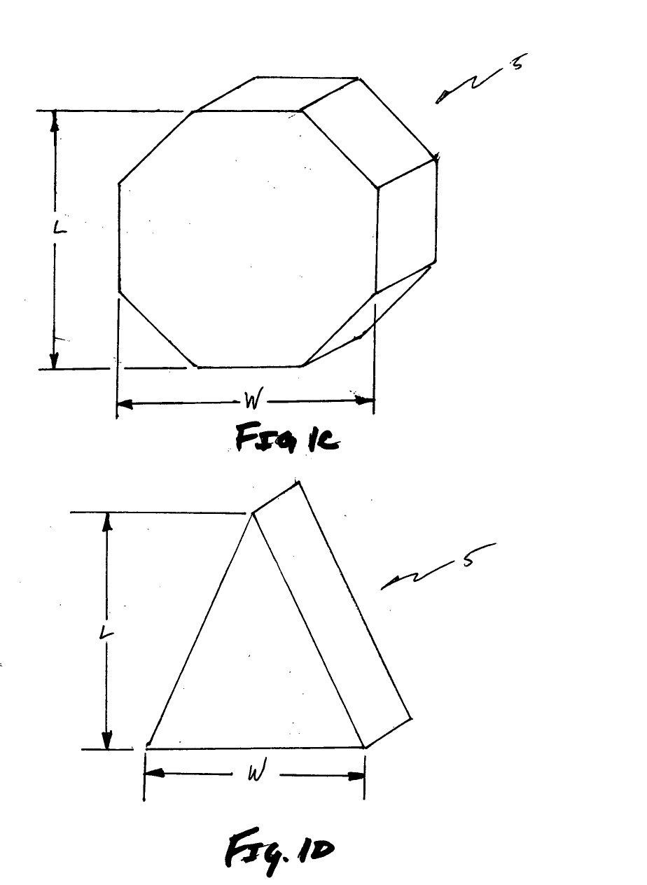

Referring now to FIGS. 1-5 a composite material is shown herein that contains aggregate particles that are adapted to elastically deform. More specifically, a concrete mixture 1 is shown which contains rubber aggregate 5. Generally, concrete is a mixture of cement, water, and aggregate. Commonly sand or gravel of various dimensions, depending on the intended purpose of the finished product, is used as aggregate. One embodiment of the present invention uses recycled rubber of predetermined sizes and geometric shapes as an aggregate material in order to improve the finished product's resistance to impacts, and to improve the overall performance characteristics of the composite material.

Referring now to FIG. 1, various shapes and dimensions of rubber aggregate 5 used in one embodiment of the present invention are shown herein. Initially, it should be understood that the shapes shown in FIG. 1 are not the only shapes, that may be employed to achieve the intended results of the present invention. In addition, a single shape of an aggregate 5 or combinations thereof may be used to achieve the desired result of providing a concrete mixture that will be less susceptible to damage by impact or an explosive blast. However, it should be appreciated by one skilled in the art that the choice in rubber aggregate shape is not random, for example as produced in traditional rubber aggregate processing operations. More specifically, one embodiment of the present invention employs rubber aggregate wherein about 40% or more of the particles have generally the same shape. The rubber tire aggregate employed in the present invention may be any source used for rubber tires such as, polybutadiene rubber, a styrene-butadiene rubber, or a cis-1,4-polyisoprene rubber, either synthetic or natural in origin, and with or without steel strings, cords, fibers, ropes, cables and studs. The preferred shape of the rubber aggregates is a square, a rectangle, a triangle, or a zig zag shape resembling a lightening bolt. Ideally the length and the width ratio will be about equal (1:1). In the case of a triangular shape, an isosceles triangle is the preferred shape of one embodiment of the present invention. Maintenance of high elastic moduli in the composite rubber aggregate particles will result in compositions similar to traditional rock aggregate concrete mixtures.

The preferred rubber aggregate particle size distribution of one embodiment of the present invention is such that about 90-95% of the weight of rubber particles is about 20% below the largest rock aggregate weight in the composite. The shape distribution of rubber aggregate may vary depending upon the desired material properties of the finished composite concrete.

The rubber aggregate 5 is obtained ideally by cutting used tires with a special saw, punch, or high-pressure water jet. By cutting the rubber tires with a saw, punch, or high-pressure water jet, instead of processing or grinding, the rubberized aggregate 5 maintains a high elastic modulus. Thus, it is desirable to provide a rubberized aggregate 5 that has a high elastic modulus that more closely matches the moduli of the mixture's other constituent parts, such as gravel aggregate, so that the homogeneity of the finish product is maintained. That is, a particulate with a low elastic modulus would increase the likelihood of localized moduli disparagements, which may effect the structural behavior of the finished product. In addition, cutting the parent material with a water jet yields particles with smooth edges that facilitate aggregate/cement bonding, and thus providing a composite material with enhanced material properties. For example, one embodiment of the present invention possesses a high degree of resistance to dynamic impact from explosions, mechanical impulse loading, etc. Further, the concrete composition is able to more effectively absorb the kinetic energy of an impact, thus reducing or eliminating spalling.

The rubber aggregates are generally square, rectangular, or triangular. In one embodiment of the present invention, the length and the width ratio are about equal. The thickness of the rubber particles is important with respect to the structural stiffness matrix of the concrete material. If the thickness of the rubber aggregate 5 is closer in magnitude to the length and width of the rubber aggregate 5 the stiffness of the rubber aggregate will increase. Thus, the shape of the rubber aggregates is cubic in one embodiment of the present invention. This shape and stiffness provides better aggregate bonding. In the case of a triangular shape 10, an isosceles triangle would be the preferred shape. In addition, other shapes, such as an octagon or a zig zag pattern may be employed.

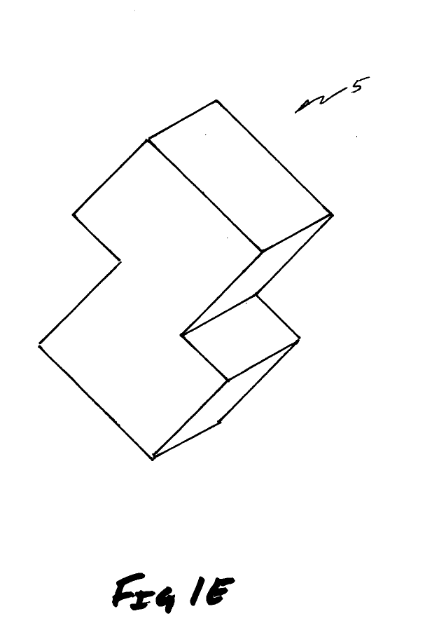

Referring now to FIG. 2, concrete mixtures 1 of the present invention are shown herein that employ rubber aggregates 5. As stated above, one embodiment of the present invention provides a concrete composition utilizing rubber aggregates 5 as a component of the composition. The preferred source of the rubber constituent in the compositions is recycled rubber from sources such as used automobile tires. The compositions of the present invention are termed composite rubberized concrete in that they generally contain a mixture of cement, water, and fine and coarse aggregate in addition to rubber aggregate 5.

More specifically, the composite rubberized concrete contains conventional constituents such as Portland cement, water, and aggregate, wherein Portland cement includes tricalcium silicate and dicalcium silicate. The most common constituent used to manufacture Portland cement includes compounds such as CaO, SiO₂, Al₂O₃, Fe₂O₃, MgO, So₃, Na₂O, K₂O, CO₂, H₂O and Ca₂SiO₅. The rubber aggregate 5 used in the concrete composition may generally be defined in two classes: fine and coarse. Coarse aggregates are those which would be retained by a #4 sieve. Conversely, fine aggregate typically has a particle size distribution in accordance with the standard distribution set forth in the American Society for Testing and Materials (ASTM) C-33 specification, which is incorporated in its entirety herein. The relative proportion of each constituent in the composite rubberized concrete may vary depending upon the desired compressive strength desired in the final cured composition. Other properties such as, modulus of elasticity, shrinkage, creep, durability, and impermeability may also be affected by the composition formulation of the mixture. Preferably, the amount of rubber aggregate in the composite rubber concrete material will not be less than about 0. 1% in total weight and should not be more than about 35% in total weight.

Compressive strength of the composite rubberized concrete may be increased or influenced by adding and mixing selective additive agents and by altering the proportion of the rubberized aggregate in the composite concrete. For example, it may convenient to add a relatively small amount of fly ash to the composition, preferably in the place of a portion of the cement content. In one embodiment of the present invention, the rubber aggregate 5 is blended with the Portland cement, fly ash, water and the other aggregates, wherein the rubberized concrete constitutes about 35% of the total weight. Such a mixture has the compressive strength (pursuant to ASTM C-192-76) of about 100 to 6000 PSI. Furthermore, the addition of a superplasticizer, such as a new generation of water-reducing admixtures, generally high-range water-reducing admixture (HRWRAs), allows for compressive strength of at least about 2500 PSI to 3500 PSI, and in some cases at least 5000 PSI.

The composite rubberized concrete of the present invention will have not only compressive strengths comparable to traditional concrete, but also possesses superior workability and exhibit extremely favorable behavior under impact loading. More specifically, the composition of the present invention will reduce or avoid the spalling effect during impact. More specifically, conventional concrete materials used for barriers, hardened structures, and other protection applications, are known to “spall”, which is caused by a tensile shock wave, which occurs during loading the material beyond its tensile yield point. This spalling or high velocity fragmentation, causes extensive collateral damage to the very assets the protection device is designed to protect.

The present invention's inclusion of rubber aggregates also results in a finished product that possesses a lower density than that of traditional concrete. The addition of fly ash or other similar materials will further decrease the density of the mixture. Thus, the resulting concrete composite material is lighter with an increased live load capacity wherein live load is the load of the concretes own weight. Thus, transportation and handling is less expensive than traditional concrete compositions. In addition, due to the relatively high elasticity of the rubber aggregates 5, the composite rubberized concrete mixture also provides a mixture that is more easily formed and placed. For example, the present invention has been tested as a material adapted to be used for noise barrier applications along highways and in applications requiring improved heat insulation, vibration dampening, toughness, and especially impact resistance.

The present invention is also suitable for use with traditional concrete compositions. More specifically, it is envisioned that the present invention be employed with traditional concrete to enhance its resistance to impacts. For example, a layer of rubberized concrete may be added to an existing concrete structure to enhance its resistance to impact loads. Alternatively, the composition of the present invention may be employed in a sandwich of various types of concrete mixes, thus providing a finished product with the combined attributes of the individual sections of concrete.

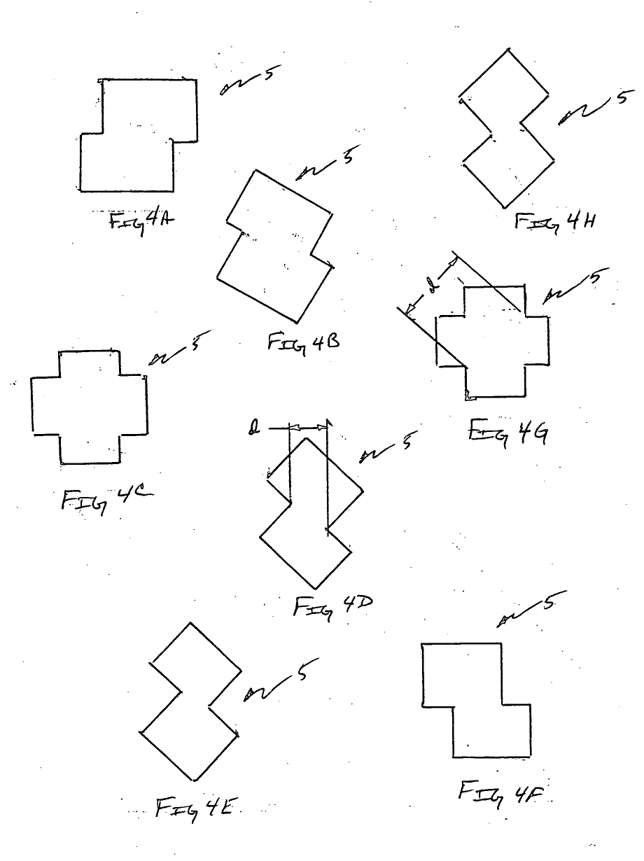

Referring now to FIG. 4, alternate shapes of rubber aggregate are shown herein. Aggregate that employ a smaller mid-section are more suited for torsional loading situations, because they possess regions of decreased bending stiffness. Preferably, in one embodiment of the present invention, the cross sectional shape of the rubber aggregate is in the form of offset rectangles or zig zags, wherein a portion thereof employs a reduced width (d). This aspect of one embodiment of the present invention allows the composite material to behave, as described above, during tension and compression loading, but also increases the composite material's torsional loading properties. More specifically, the thinner portion of the aggregate (d) enables the aggregate to better accommodate localized torsional loads. Other aggregate shapes, as described above, have significantly greater mechanical contact with the surrounding concrete and possess greater bending stiffness, thus becoming shear load concentrations that often cause material failure. Alternatively, a cross shape may be employed to enhance the torsional loading characteristics of the composite material, however, construction of such a cross-shaped aggregate may be more expensive. It should be appreciated by one skilled in the art that varying width (d) will change the torsional properties of the composite material.

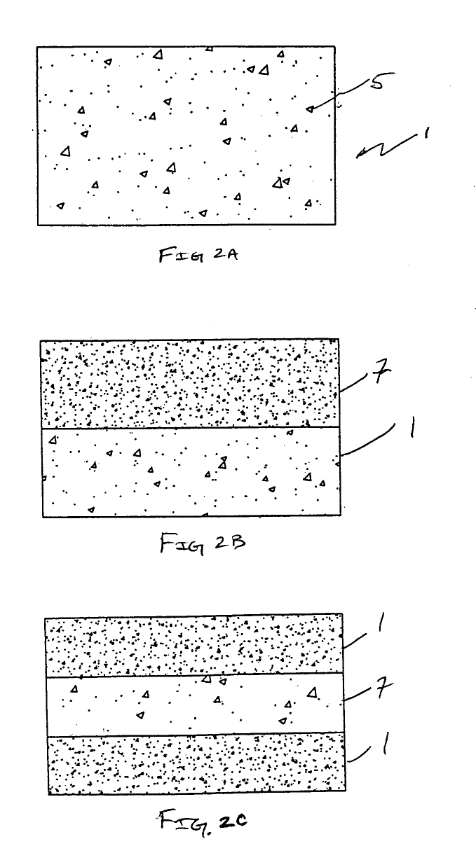

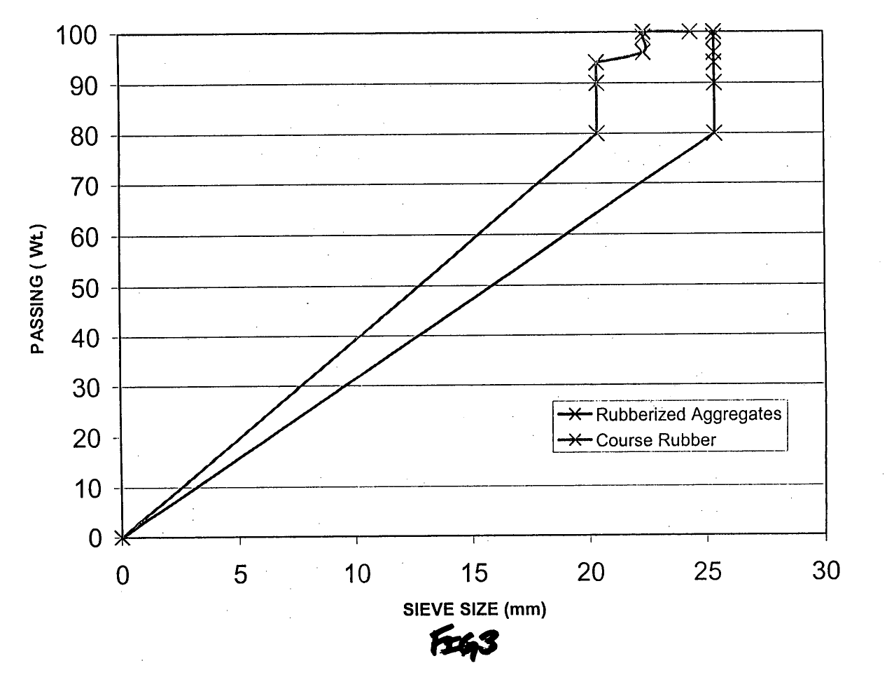

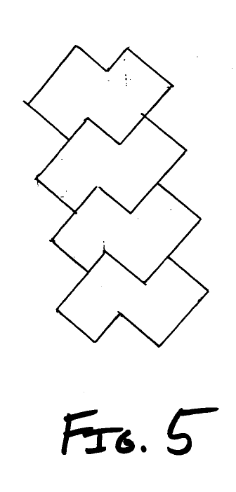

Referring now to FIGS. 1-5, a method of making one embodiment of the present invention is shown and described herein. Initially, the intended use of the finished product, along with the environmental factors it will be exposed to, are assessed. For example, expected compressive loads, vibrational environment, impact susceptibility, temperature, moisture, etc. These and other factors are routinely assessed by those skilled in the art before any concrete mixture is selected for a given task, because information as to these and other factors will help determine the cement type, aggregate type and size, water and air content, etc. Next the rubber aggregates 5 are cut and/or sorted to obtain the desired size particles. As mentioned above, the rubber source, such as a used tire, should be cut to the predetermined shape by a special saw, punch, or water jet in order attain generally smooth edges. FIG. 5, for example, shows a possible way to cut or punch a plurality of shaped aggregate to conserve material and thus save cost. Since the rubber tire is a composite material itself, there exists a chance that steel threads, or any other constituent of the tire, will be liberated during the cutting, thus they should be removed from the aggregate before mixing it with the concrete. Next, the rubber aggregates should preferably be subjected to a washing process to remove hydrophilic and hydrophobic contaminants or any introduced grease or grinding materials. Water, carbon tetrachloride, and other commonly used industrial solvents and combination thereof may be used to wash the rubber aggregates. Referring now to FIG. 3, the rubber aggregate should be sorted by size. Generally a sieve employing a predetermined aperture size is used to sort materials by allowing smaller particles to pass through while the screen traps larger particles. For example, FIG. 3 shows an example of grading curves used to assess the total percentage passing and retained basis, respectively. Once the rubber and other aggregate are sorted by size, they are added to the cement and water mixture to form a composite material. Constant mixing, as generally done in the art, will ensure homogeneity in the finished product. As shown in FIG. 2, the rubberized concrete 1 may be used by itself or in combination with traditional concrete 7. In addition, due to its increase workability, the rubberized concrete 1 of one embodiment of the present invention may be formed by pouring it into molds and cured.

One embodiment of the present invention, also known as pervious rubberized concrete, is adapted to allow water to penetrate therethrough. More specifically, this embodiment employs voids integrated into the concrete matrix, thereby providing inherent permeability and means for enhanced drainage capabilities. For example, the pervious mixture may be used in the construction of parking lots to reduce the need for drainage systems, wherein water penetrates the concrete surface to a sub-base or base of the parking lot to be drained. The pervious concrete mixture preferably combines equal size rubber aggregate, or a mix or rubber and natural aggregates, with cement and water. If a mixture same-size rubber and natural aggregates are employed, it is preferred that an equal amount of each, by volume, is used. A cubic yard of this embodiment of the present invention preferably contains from about 600 to 630 pounds of cement, about 2,000 to 2,500 pounds of natural aggregate, and a water ratio of about 0.3 to 0.8.

In order to validate the performance of the present invention, it was tested against traditional concrete mixtures. The test generally encompassed compression strengths of various concrete castings employing various grades of rubber aggregate. Initially, two particulate rubber aggregate samples having particle size distribution as shown in FIG. 3 were used for the study. The concrete mixtures were then prepared with rubber samples in accordance with the mixture set forth in Table 1 below. A control sample was also prepared having no added rubber, wherein the weight of the rubber was replaced by coarse aggregates. Thus, the control sample did not contain any of rubber aggregates and was mainly used for comparison.

TABLE 1
Concrete Mix

| Component | Amount | % |
|---|---|---|
| Aggregates | 33.1 lbs. | 25.8 |
| Sand | 58.8 lbs. | 45.9 |
| Rubber Aggregates | 6.6 lbs. | 5.2 |
| Portland Cement | 19.7 lbs. | 15.4 |
| Water | 9.9 lbs. | 7.7 |

The coarse aggregate and rubber aggregates were added to a machine mixer with a portion of the water. The mixer was started and the sand, Portland cement, and remaining water were added and the mixer for about three minutes. The concrete mix was then allowed to stand for about three minutes, and then mixed again for two minutes. The concrete mixes were then used to prepare specimens for a compression test (pursuant to ASTM C-39). The results of the compression tests for the rubberized aggregate samples are set forth in Table 2. As may be seen from the results, the compression strength was significantly increased for the sample of rubberized aggregate in comparison with sample with coarse aggregate.

TABLE 2
Results from Compressive Strength Tests

| Rubber Samples | Compression Strength (Psi) |
|---|---|
| Coarse Aggregate | 3200 |
| Rubber Aggregate | 3870 |
| Control | 4000 |

To assist in the understanding of the present invention the following list of components and associated numbering found in the drawings is provided herein:

| Component | # |
|---|---|
| Rubberized concrete mixture | 1 |
| Rubber aggregate | 5 |
| Traditional concrete mixture | 7 |

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

1. A concrete composition comprising:
cement; and
rubber aggregate comprised of a predetermined size and shape, wherein said rubber aggregate is between about 0.01 and about 35 percent by weight of said concrete composition, and wherein said concrete composition is resistant to impact.

2. The concrete composition of claim 1, wherein about 50 to about 95percent of the weight of said rubber aggregate is adapted to pass through a 1-inch sieve.

3. The concrete composition of claim 1, wherein about 20 to about 75percent of the weight of said rubber aggregate is adapted to pass through a 0.95-inch sieve.

4. The concrete composition of claim 1, wherein about 0 to about 30 percent of the weight of said rubber aggregate is adapted to pass through a 0.85-inch sieve and less than about 10 percent of the weight of said rubber aggregate is retained on a 0.75-inch sieve.

5. The concrete composition of claim 1, wherein said cement is present in an amount of from about 5 to about 20 percent by weight of the total composition.

6. The concrete composition of claim 1, wherein the shape of a cross section of individual particles of said rubber aggregate is generally at least one of a square, a triangle, a rectangle, an octagon, a cross, and a zig zag.

7. The concrete composition of claim 1, wherein said rubber aggregate is generated from rubber tires that are cut such that the resulting edges are generally smooth.

8. A method of making a concrete composition, comprising the steps of:
providing a source of rubber aggregate;
cutting said source of rubber aggregate into predetermined shapes;
sorting said rubber aggregate of predetermined shapes by size dictated by the intended use of the concrete composition;
mixing cement and water to create a composite material; and
adding said aggregate of predetermined shapes to said composite material, wherein a concrete composition is formed that possesses increased resistance to impact loads.

9. The method of claim 8, further comprising the step of adding an additive to the composite material, wherein said additive is sand, gravel, plasticizer, carbon fiber, fiberglass, reinforcing members, or fly ash.

10. The method of claim 8, further comprising the step of cleaning said aggregate of predetermined shapes before said adding step.

11. The method of claim 8, wherein the shape of a cross section of a majority of said smaller pieces of rubber is substantially at least one of a triangle, a rectangle, a square, an octagon, a cross, or a zig zag.

12. The method of claim 8, wherein said aggregate of predetermined shapes are cut by at least one of a water jet, an abrasive water jet, and a punch, wherein the sides of said aggregate of predetermined shapes have a substantially smooth surface.

13. A composite concrete material, comprising:
a cement mix;
a predetermined quantity of water;
a plurality of voids within said concrete composition that facilitate fluid drainage through said concrete material;
a rubber aggregate of predetermined shapes and sizes, wherein said rubber aggregate is between about 0.01 and about 35 percent by weight of said concrete composition; and
a natural aggregate of substantially the same size as said rubber aggregate, wherein said concrete composition is resistant to impacts.

14. The concrete material of claim 13, wherein the weight of said cement per cubic yard of said concrete material is about 600 to 630 pounds.

15. The concrete material of claim 13, wherein the weight of said natural aggregate per cubic yard of said concrete material is between about 2,000 to 2,500 pounds, wherein the weight of said rubber aggregate is between about 1,300 pounds.

16. The concrete composition of claim 13, wherein the shape of a cross section of the individual particles of said rubber aggregate is generally at least one of a square, a triangle, a rectangle, an octagon, a cross, and a zig zag.

17. The concrete material of claim 16, wherein said zig zag shape has a height of about 3.5 centimeters (1.38 inches), a thickness of about 5-10 centimeters (1.97-3.34 inches), and a width of about 2 centimeters (0.79 inches).

18. The concrete material of claim 13, wherein the torsional modulus is about 6.52×10⁶ PSI (44.94 GPa) after a 21 day cure.

19. The concrete material of claim 13, wherein the compression strength is about 3000 PSI after a 21 day cure.

20. The concrete material of claim 16, wherein about 10-40% of said individual particles of said rubber aggregate are zig zag shaped.

21. The concrete composition of claim 13, wherein said rubber aggregate is generated from rubber tires that are cut such that the resulting edges are generally smooth.
